(19) United States
(12) Patent Application Publication
(10) Pub. No.: US 2026/0326580 A1
(43) Pub. Date: Oct. 22, 2026

(54) SYSTEMS AND METHODS FOR DIRECT ELECTRIC VEHICLE CHARGING FROM DIRECT CURRENT GENERATORS

(71) Applicant: PROLOGIS, L.P., San Francisco, CA (US)

(72) Inventor: Casper Jan-Theo Hendrik Steenkamp, San Francisco, CA (US)

(21) Appl. No.: 19/182,425

(22) Filed: Apr. 17, 2025

(51) Int. Cl. B60L 53/10; B60L 53/57; B60L 53/62; B60L 53/65; B60L 53/66; H02J 1/08; H02J 1/10

(52) U.S. Cl. CPC B60L 53/11; B60L 53/57; B60L 53/62; B60L 53/65; B60L 53/66; H02J 1/084; H02J 1/106

(57) ABSTRACT

A system of direct current (DC) generators and a switching matrix can charge electric vehicles (EVs). The switching matrix can connect the generators in different series and parallel combinations to match the specific voltage and current needs of each EV. The system can adapt to various EV models and future charging standards by reconfiguring the generator connections, making it a flexible solution for changing EV charging infrastructures.

### BACKGROUND

The rapid growth of electric vehicle (EV) adoption presents significant challenges and opportunities for charging infrastructure. Many EV charging systems rely on alternating current (AC) power supplied by the power grid, which can lead to capacity constraints and limitations in charging speed. Additionally, many existing EV charging systems require complex power conversion equipment to integrate with the power grid, leading to efficiency losses and increased costs.

### BRIEF DESCRIPTION OF THE DRAWINGS

Detailed descriptions of implementations of the present technology will be described and explained through the use of the accompanying drawings.

FIG. 1 is a block diagram illustrating three systems for charging electric vehicles, in accordance with various embodiments of the present technology.

FIG. 2 is a block diagram illustrating a system for charging electric vehicles directly from a matrix of direct current generators, in accordance with various embodiments of the present technology.

FIG. 3 is a flow diagram illustrating a method of charging electric vehicles directly from a matrix of direct current generators, in accordance with various embodiments of the present technology.

FIG. 4 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Electric vehicles (EVs) are becoming increasingly popular, but their widespread adoption depends heavily on the availability of reliable and efficient charging infrastructure. Many EV charging systems rely on the power grid, which often faces limitations in capacity, especially during peak demand. This can lead to delayed deployments or slow charging times and potentially hinder the expansion of EV charging networks, particularly for large-scale deployments, such as commercial fleet charging hubs.

To overcome these limitations, distributed energy resources (DERs), such as generators and batteries, can be used. DERs can provide on-site power for EV charging, reducing reliance on the power grid and offering greater flexibility. Many EV chargers are primarily designed to work with the standard alternating current (AC) power from the power grid and use power conversion equipment to receive the direct current (DC) power produced by generators. This DC to AC conversion process can result in energy losses, making the charging less efficient and more expensive, particularly when using renewable or low-carbon fuels.

DC microgrids and DC-compatible EV chargers have been developed to minimize the number of steps of the conversion process. While DC microgrids and DC-compatible EV chargers offer some efficiency gains, they can require specialized equipment and may not be compatible with all EVs.

The present technology bypasses the need for separate EV chargers and complex power conversion systems. The charging system utilizes a network of inherently isolated controllable DC generators directly connected to a controllable switching matrix. This matrix allows the generators to be dynamically combined in series and/or parallel configurations, effectively creating a customizable “virtual charger” capable of meeting the specific voltage and power needs of a wide range of EVs.

The direct connection between the distributed controllable DC generators and the EVs eliminates the need for an AC-DC-DC-AC conversion, significantly reducing energy losses and improving overall efficiency. The ability to dynamically adjust the voltage and current output through the switching matrix ensures optimal charging for each EV, regardless of its battery capacity or charging requirements. This adaptability also provides a degree of future-proofing, as the system can easily accommodate emerging higher-voltage EV models and charging standards simply by reconfiguring the generator connections within the matrix. The system presents a more efficient, adaptable, and cost-effective solution for EV charging, especially in scenarios where DERs are utilized.

The present technology provides advantages over many EV charging methods, particularly in its efficiency and adaptability. Some EV charging infrastructure, whether based on AC or DC power grids, relies on separate EV chargers and power conversion equipment to interface with DERs, such as generators. This results in energy losses during the conversion process, reducing overall efficiency and increasing costs, especially when using more expensive low-carbon fuels. The present technology provides direct current and voltage controllable DC-to-DC connection between the generators and EVs eliminates the need for separate EV chargers and multiple conversion steps, minimizing energy losses and maximizing efficiency.

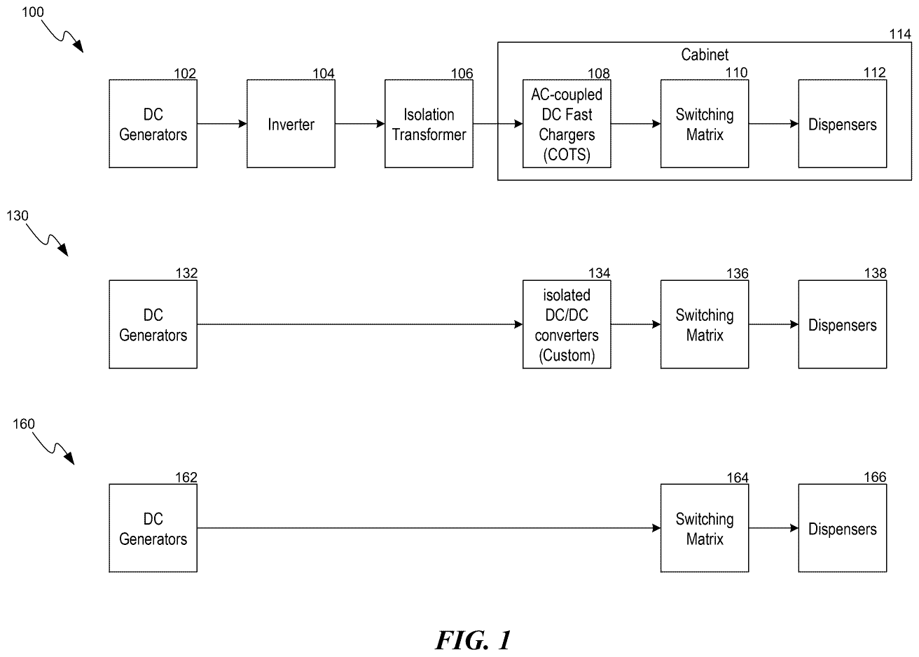

FIG. 1 is a block diagram illustrating three systems for charging electric vehicles, in accordance with various embodiments of the present technology. System 100 performs a series of power conversion steps that can introduce inefficiencies and energy losses. Direct current (DC) generators 102 generate DC power. The DC generators 102, while capable of producing the required power, are not inherently isolated. For example, the DC generators 102 lack a physical separation between their internal circuits and the output, posing a potential safety risk. To address this safety concern and ensure compatibility with the power grid, the DC output from the DC generators 102 is fed into an inverter 104. The inverter 104 is an electronic device that converts DC power into alternating current (AC) power, the standard form of electricity used in many power grids. The conversion process can introduce some energy losses (e.g., in the range of 5-10%) depending on the inverter's efficiency. The AC output from the inverter is then passed through an isolation transformer 106. The transformer 106 can serve two primary purposes, by: 1) providing galvanic isolation to create a physical barrier between the input and output circuits to prevent electrical shocks and ensure safety; and 2) stepping up or down the voltage of the AC power to match the requirements of the EV charger.

The isolated AC power is then delivered to AC-coupled EV chargers 108. The AC-coupled EV chargers 108 are specialized isolated devices designed to convert AC power back into DC power at the voltage and current levels required for charging an EV battery. This AC-to-DC conversion can introduce energy losses, further reducing the overall efficiency of the charging process. The isolation layer within can also be redundant if isolated DC generators are already available.

From the EV chargers 108, the DC power is routed to a switching matrix 110, which is a network of switches that allows multiple charging dispensers to be connected to the system, each isolated from each other. The switching matrix 110 enables flexible allocation of the available charging power to different EVs and can also facilitate load balancing to optimize the utilization of the charging infrastructure. The DC power is routed from the switching matrix to the dispensers 112, which are the physical points of connection between the charging system and the EVs. The dispensers 112 can include safety features and communication protocols to ensure secure and controlled charging. The AC-coupled EV charger 108, the switching matrix 110, and the dispensers 112 can be housed in a cabinet 114 but dispensers 112 are often in separate cabinets.

System 130 can improve charging efficiency by reducing the number of conversion steps of the EV charging process. DC generators 132 can generate DC power. System 130 can utilize isolated DC/DC converters 134 instead of inverters and isolation transformers (as described in system 100).

An isolated DC/DC converter 134 can serve a dual purpose, by: 1) providing galvanic isolation, ensuring safety by separating the input and output circuits; and 2) converting the DC power from the generators to a different DC voltage level (e.g., matching the requirements of the EV battery or the charging infrastructure). By using isolated DC/DC converters 134, system 130 eliminates the need for AC conversion, thereby reducing energy losses associated with the inverter and transformer stages. This results in a higher overall efficiency compared to system 100. The DC output from the isolated DC/DC converters 134 is directed to a switching matrix 136, similar to switching matrix 110 of system 100. The switching matrix 136 allows for flexible connection of multiple dispensers and enables efficient management of the charging process. The DC power reaches the dispensers 138, providing the interface for connecting and charging EVs.

System 160 leverages the inherent characteristics of current and voltage controllable isolated DC generators 162 and a switching matrix 164 to deliver direct DC-to-DC charging, maximizing efficiency and flexibility. DC generators 162 are inherently galvanically isolated. This inherent isolation eliminates the need for additional isolation equipment like transformers, simplifying the system architecture and reducing costs. Furthermore, the DC generators 162 are designed to operate within the voltage and current ranges required for EV charging, allowing for direct connection to the EVs' batteries without the need for intermediary conversion stages (e.g., DC/DC converters 134 of system 130 or inverter 104 and isolation transformer 106 of system 100).

The DC generators 162 are connected to a controllable switching matrix 164. The switching matrix 164 comprises a network of electrically conductive paths, each capable of connecting any number of DC generators to any number of dispensers. The switching matrix 164 can allow the DC generators 162 to be dynamically combined in various series and/or parallel configurations, enabling the system 160 to precisely match the voltage and current demands of different EVs. Connecting the DC generators 162 in series increases the output voltage, while connecting them in parallel increases the output current. This flexibility allows the system 160 to accommodate a wide range of EV models and battery technologies, ensuring optimal charging performance for each vehicle.

The output of the switching matrix 164 is directly connected to the charge control dispensers 166, bypassing the need for dedicated EV chargers. The dispensers 166 can serve as the interface between the system 160 and the EVs, regulating the flow of DC power to each connected vehicle. The system 160 can operate as an energy management system and intelligently manage the charging process. The system 160 can constantly monitor the status of each component, including the generators 162, the switching matrix 164, and dispensers 166, ensuring safe and efficient operation.

The system 160 can control the switching matrix 164, dynamically reconfiguring the connections between the generators 162 and dispensers 166 based on predefined rules. These rules prioritize the allocation of charging power to different EVs, optimizing resource utilization and accommodating various charging scenarios. For instance, the rules can prioritize charging for specific vehicles based on their battery level, urgency of need, or other predefined criteria. Alternatively, the rules can enable simultaneous charging of multiple EVs, dynamically adjusting the power distribution based on the real-time charging demands and available generator capacity.

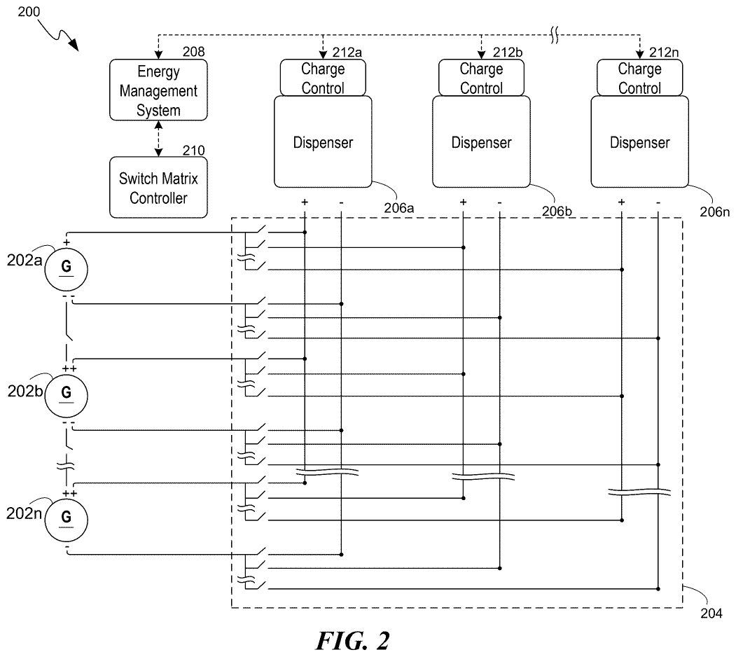

FIG. 2 is a block diagram illustrating a system 200 for charging electric vehicles directly from a matrix of DC generators, in accordance with various embodiments of the present technology. The system 200 can include a plurality of DC generators 202a, 202b, . . . and 202n (two or more of which are collectively referred to herein as “DC generators 202”), a switch matrix 204, charge control dispensers 206a, 206b, . . . and 206n (two or more of which are collectively referred to herein as “dispensers 206”), a switch matrix controller 210, and an energy management system 208. Each of the dispensers 206 is connected to or includes a charge control unit 212 (e.g., 212a, 212b, . . . and 212n) that regulates the flow of DC power to a connected EV.

The DC generators 202, the switch matrix 204, and the dispensers 206 can be operate similarly to the generators 162, the switching matrix 164, and dispensers 166 described above with reference to FIG. 1. The DC generators 202, the switch matrix 204, and the dispensers 206 are interconnected to form a closed-loop system that facilitates efficient and adaptable EV charging. The switching matrix 204 connects the DC generators 202 to the dispensers 206, enabling the system 200 to dynamically adjust the voltage and current output to meet the specific charging requirements of different EVs.

The DC generators 202 generate the power for the charging system. The number of generators used can vary based on the power needs of the charging station. The DC generators 202 can be arranged in any combination of series and parallel connections to meet the specific voltage and current requirements of the EVs being charged. The DC generators 202 can be inherently galvanically isolated. This means there is no direct electrical connectivity between the generator's output and earth ground, enhancing the system's safety and meeting isolation requirements of Electric Vehicles connected to Dispensers (206). The DC generators 202 can include but are not limited to linear generators, reciprocating engines, fuel cells, energy storage systems, and filters.

The output of the DC generators 202 is fed into the switch matrix 204 controlled by the switch matrix controller 210. The switch matrix 204 is a network of electrically controlled switches (contactors) that can dynamically connect any number of generators in various series and parallel configurations based on the needs of the dispensers 206. This allows for a high degree of flexibility in matching the output voltage and current of the generator matrix to the charging requirements of different EVs. For example, if an EV requires a higher voltage than the output of a single generator, the switch matrix controller 210 can connect multiple generators in series to achieve the desired voltage. Conversely, if an EV requires a higher current than a single generator can provide, the switch matrix controller 210 can connect multiple generators in parallel. The ability to dynamically reconfigure the generator connections ensures that the system can efficiently charge a wide range of EVs with varying voltage and current requirements. For example, any number of generators 202 can be linked with any number of dispensers 206.

The output of the switch matrix 204 is connected to the dispensers 206. The dispensers 206 can act as the interface between the charging system and the EVs. Each dispenser includes a charge control unit 212 that regulates the flow of DC power to the connected EV, ensuring safe and efficient charging. The dispensers 206 can control the charging process at each individual charging point. This localized control ensures that each EV receives the appropriate charging parameters regardless of the configuration of the generator matrix.

The Energy Management System (EMS) 208 can monitor and control all aspects of the charging process. The EMS 208 can continuously monitor the status of each component, including the generators 202, the switch matrix 204, and dispensers 206. Based on this real-time information, the EMS 208 can orchestrate the operation of the switch matrix 204, dynamically reconfigure the connections between generators 202 and dispensers 206 to optimize power allocation and meet the charging demands of the connected EVs. This intelligent management ensures the system operates at peak efficiency while prioritizing charging based on predefined rules or specific vehicle needs. For example, the EMS 208 coordinates the charge control at the dispenser level based on the needs of the vehicle battery and the availability of generators.

The EMS 208 can be programmed with custom prioritization rules for how DC generators are to be shared with a fleet of vehicles. These rules determine how the generators are allocated to different EVs, prioritizing which vehicle gets charged first or allowing simultaneous charging based on available resources. For instance, the system 200 could employ a simple first-in, first-out approach, where the vehicle that connects first receives priority charging. Alternatively, a dynamic parallel charging rule could enable simultaneous charging of multiple vehicles, adjusting the power distribution based on each EV's charging requirements and the available generator capacity. The EMS 208 can also be programmed to prioritize specific vehicles based on predetermined factors, such as urgency of need or battery level. This rule-based approach allows for efficient and flexible management of EV charging, optimizing resource utilization and accommodating various charging scenarios.

System 200 provides advantages over many EV charging system. Primarily, it eliminates the need for separate EV chargers, which are typically used to convert AC power from the grid to DC power suitable for charging EV batteries. By directly connecting the DC generators 202 to the EVs through the switch matrix 204, the system 200 bypasses the energy losses associated with an AC-to-DC conversion. Direct DC-to-DC charging significantly increases the overall efficiency of the system, reducing energy consumption and operating costs. Furthermore, the system's flexibility in combining generators in series and parallel configurations allows it to accommodate a much wider range of EV models and battery technologies compared to many charging systems. This future-proofs the system, making it compatible with emerging high-voltage EV platforms and ensuring its relevance as EV technology continues to evolve. Additionally, the dynamic control provided by the EMS 208 optimizes the utilization of the available generator capacity, allowing for simultaneous charging of multiple EVs while prioritizing charging based on predefined rules or specific vehicle needs.

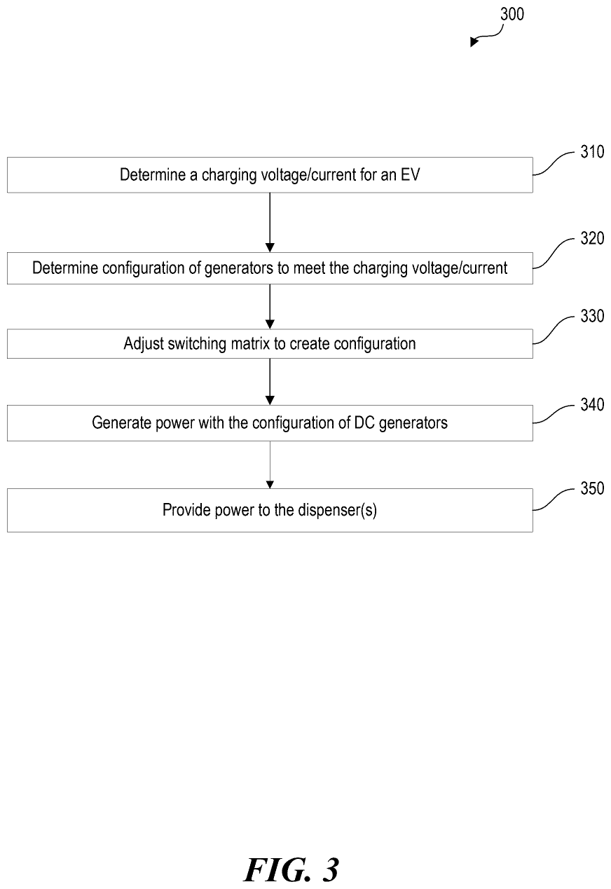

FIG. 3 is a flow diagram illustrating a method of charging electric vehicles directly from a matrix of direct current generators, in accordance with various embodiments of the present technology. The method 300 is illustrated as a series of steps 310, 320, 330, 340, and 350. All or a subset of one or more of the steps 310, 320, 330, 340, and 350 can be executed in accordance with the description above and/or with the description that follows.

The method 300 begins at step 310 by determining a charging voltage and/or current for an EV. The system can communicate with the EV to obtain information about its battery specifications and charging requirements. This communication can occur through standardized protocols, allowing the system to identify the optimal charging voltage for each specific vehicle. In some cases, charging system can analyze historical charging data and vehicle profiles to determine the charging voltage/current for different vehicle models.

In some cases, the system can employ adaptive algorithms that adjust the charging voltage/current in real-time based on the battery's response during the charging process. This dynamic approach can optimize charging efficiency and battery health. The charging voltage can also be influenced by factors such as the current state of charge of the vehicle's battery, the desired charging speed, and any user-defined preferences or constraints.

At step 320, the method 300 continues by determining the configuration of DC generators to meet the charging voltage/current. The system can calculate the number of generators to connect in series to achieve the desired voltage. For example, if each generator produces 100V and the charging voltage required is 400V, the system may determine that four generators should be connected in series. The system can also consider the current requirements of the EV when determining the generator configuration. The system can calculate the number of generators to connect in parallel to achieve the desired current. For example, if additional current is needed beyond what a single string of generators in series can provide, the system can configure multiple strings of generators in parallel.

In some implementations, the system may use a combination of series and parallel connections to achieve the desired voltage and current. For example, the system can connect two generators in series to increase voltage, then connect multiple of these series pairs in parallel to increase current capacity. Within this step selection, finer adjustments in voltage and current can be made at the generator level to achieve a continuous voltage and current range. The system can employ optimization algorithms to determine the most efficient configuration of generators. These algorithms may consider factors such as the available generators, their individual capacities, and their current operational status. Through the energy management system (200) the system can perform load balancing among the available generators. This may involve distributing the load evenly across multiple generators to prevent any single generator from being overworked, potentially extending the lifespan of the equipment.

At step 330, the method 300 continues by adjusting the switching matrix to create the configuration of DC generators. The system can activate or deactivate specific switches or contactors within the matrix to establish the desired electrical connections between generators. This may include closing switches to connect generators in series or parallel configurations as determined in step 320. At step 340, the method 300 continues by generating the power with the configuration of DC generators.

At step 350, the method 300 involves providing the generated power to the dispensers. The system can use dedicated power lines or cables to transmit the generated DC power from the configured generators to the dispensers. These power transmission components may be designed to handle high currents and voltages efficiently, minimizing power losses during transmission. The system may employ power distribution units (PDUs) to manage and allocate the generated power among multiple dispensers. PDUs may help in load balancing and ensure that each dispenser receives the appropriate amount of power based on the connected EV's charging requirements.

Although the steps 310, 320, 330, 340, and 350 of the method 300 are discussed and illustrated in a particular order, the method 300 is not so limited. In other embodiments, all or a subset of one or more of the steps 310, 320, 330, 340, and 350 of the method 300 can be performed in a different order. In these and other embodiments, all or a subset of any of the steps 310, 320, 330, 340, and 350 of the method 300 can be performed before, during, and/or after all or a subset of any of the other steps 310, 320, 330, 340, and 350 of the method 300. Furthermore, a person skilled in the art will readily recognize that the method 300 can be altered and still remain within these and other embodiments of the present technology. For example, all or a subset of one or more steps 310, 320, 330, 340, and 350 of the method 300 can be omitted and/or repeated in some embodiments.

### Computer System

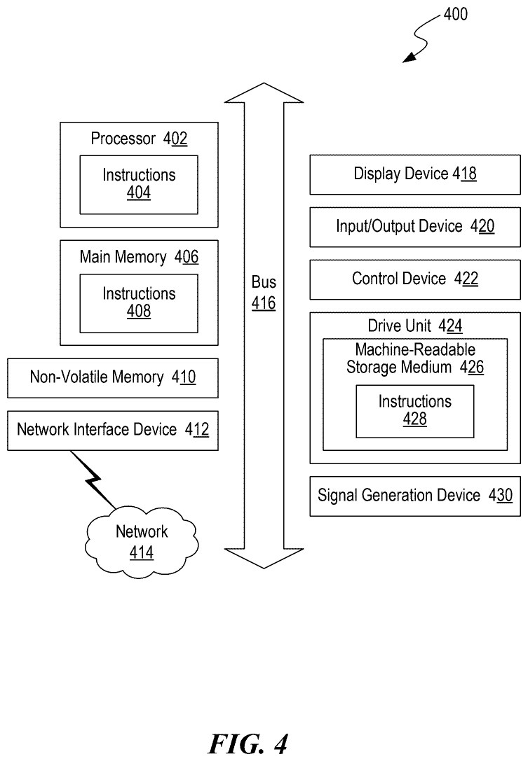

FIG. 4 is a block diagram that illustrates an example of a computer system 400 in which at least some operations described herein can be implemented. As shown, the computer system 400 can include: one or more processors 402, main memory 406, non-volatile memory 410, a network interface device 412, video display device 418, an input/output device 420, a control device 422 (e.g., keyboard and pointing device), a drive unit 424 that includes a storage medium 426, and a signal generation device 430 that are communicatively connected to a bus 416. The bus 416 represents one or more physical buses and/or point-to-point connections that are connected by appropriate bridges, adapters, or controllers. Various common components (e.g., cache memory) are omitted from FIG. 4 for brevity. Instead, the computer system 400 is intended to illustrate a hardware device on which components illustrated or described relative to the examples of the figures and any other components described in this specification can be implemented.

The computer system 400 can take any suitable physical form. For example, the computer system 400 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 400. In some implementation, the computer system 400 can be an embedded computer system, a system-on-chip (SOC), a single-board computer system (SBC) or a distributed system such as a mesh of computer systems or include one or more cloud components in one or more networks. Where appropriate, one or more computer systems 400 can perform operations in real-time, near real-time, or in batch mode.

The network interface device 412 enables the computer system 400 to mediate data in a network 414 with an entity that is external to the computer system 400 using any communication protocol supported by the computer system 400 and the external entity. Examples of the network interface device 412 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 406, non-volatile memory 410, machine-readable medium 426) can be local, remote, or distributed. Although shown as a single medium, the machine-readable medium 426 can include multiple media (e.g., a centralized/distributed database and/or associated caches and servers) that store one or more sets of instructions 428. The machine-readable (storage) medium 426 can include any medium that is capable of storing, encoding, or carrying a set of instructions for execution by the computer system 400. The machine-readable medium 426 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 410, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 404, 408, 428) set at various times in various memory and storage devices in computing device(s). When read and executed by the processor 402, the instruction(s) cause the computer system 400 to perform operations to execute elements involving the various aspects of the disclosure.

### Remarks

The terms “example”, “embodiment” and “implementation” are used interchangeably. For example, reference to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the examples, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following examples should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the examples. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

I/We claim:

1. A system for charging an electric vehicle, comprising:
a plurality of isolated direct current (DC) generators configured to generate DC power;
a switching matrix electrically coupled to the plurality of isolated DC generators, the switching matrix comprising a plurality of switches;
a controller electrically coupled to the switching matrix, the controller configured to:
selectively control the plurality of switches to connect the plurality of isolated DC generators in a series configuration;
selectively control the plurality of switches to connect the plurality of isolated DC generators in a parallel configuration; and
selectively control the plurality of switches to connect the plurality of isolated DC generators in any combination of series and parallel connections to match a charging requirement of the electric vehicle; and
a plurality of dispensers, wherein the switching matrix is configured to connect the plurality of dispensers to the plurality of isolated DC generators.

2. The system of claim 1, wherein the switching matrix dynamically connects the plurality of isolated DC generators in a configuration of series and parallel combinations during charging of the electric vehicle.

3. The system of claim 1, wherein the switching matrix is further configured to connect a plurality of electric vehicles to the plurality of isolated DC generators.

4. The system of claim 1, wherein the plurality of isolated DC generators are inherently galvanically isolated.

5. The system of claim 1, wherein the controller receives the charging requirement from the electric vehicle.

6. The system of claim 5, wherein the controller, based on the charging requirement, controls the switching matrix to connect the plurality of isolated DC generators in a combination of series and parallel connections to match a voltage or a current need of the electric vehicle.

7. The system of claim 1, wherein the controller prioritizes charging of the electric vehicle based on a set of predetermined rules.

8. A method for charging electric vehicles, comprising:
determining a charging requirement for an electric vehicle, wherein the charging requirement includes a voltage range or current range to charge the electric vehicle;
determining a configuration of a plurality of isolated direct current (DC) generators to meet the charging requirement;
adjusting a plurality of switches of a switching matrix to create the configuration of the plurality of isolated DC generators;
generating power with the plurality of isolated DC generator operating in the configuration and controlling current and voltage levels of the plurality of isolated DC generators at finer levels using an energy management system; and
providing the generated power to one or more dispensers connected to the electric vehicle.

9. The method of claim 8, wherein determining the charging requirement comprises:
communicating with the electric vehicle to obtain battery specifications and charging requirements.

10. The method of claim 8, wherein determining the configuration of the plurality of isolated DC generators comprises:
calculating a number of generators to connect in series to achieve the voltage range.

11. The method of claim 8, wherein determining the configuration of the plurality of isolated DC generators comprises:
calculating a number of generators to connect in parallel to achieve the current range.

12. The method of claim 8, wherein adjusting the plurality of switches of the switching matrix comprises:
activating or deactivating specific switches within the switching matrix to establish electrical connections between the plurality of isolated DC generators.

13. The method of claim 8, further comprising:
dynamically connecting the plurality of isolated DC generators in a configuration of series and parallel combinations during charging of the electric vehicle.

14. The method of claim 8, wherein the plurality of isolated DC generators are inherently galvanically isolated.

15. A non-transitory computer-readable medium storing instructions that, when executed by a computing system, cause the computing system to perform operations for charging electric vehicles, the operations comprising:
determining a charging requirement for an electric vehicle, wherein the charging requirement includes a voltage range or current range to charge the electric vehicle;
determining a configuration of a plurality of isolated direct current (DC) generators to meet the charging requirement;
adjusting a plurality of switches of a switching matrix to create the configuration of the plurality of isolated DC generators;
generating power with the plurality of isolated DC generator operating in the configuration and controlling current and voltage levels of the plurality of isolated DC generators at finer levels using an energy management system; and
providing the generated power to one or more dispensers connected to the electric vehicle.

16. The non-transitory computer-readable medium of claim 15, wherein the operations further comprise:
communicating with the electric vehicle to obtain battery specifications and charging requirements.

17. The non-transitory computer-readable medium of claim 15, wherein the operations further comprise:
calculating a number of generators to connect in series to achieve the voltage range.

18. The non-transitory computer-readable medium of claim 15, wherein the operations further comprise:
calculating a number of generators to connect in parallel to achieve the current range.

19. The non-transitory computer-readable medium of claim 15, wherein the operations further comprise:
activating or deactivating specific switches within the switching matrix to establish electrical connections between the plurality of isolated DC generators, wherein the plurality of isolated DC generators are inherently galvanically isolated.

20. The non-transitory computer-readable medium of claim 15, wherein the operations further comprise:
dynamically connecting the plurality of isolated DC generators in a configuration of series and parallel combinations during charging of the electric vehicle.
